(19) United States
(12) Patent Application Publication
(10) Pub. No.: US 2025/0091940 A1
(43) Pub. Date: Mar. 20, 2025

(54) HIGH-HARDNESS ELECTRONIC GLASS AND PREPARATION METHODS THEREOF

(71) Applicant: CAIHONG DISPLAY DEVICES CO., LTD., Xianyang (CN)

(72) Inventors: Jing LAN, Xianyang (CN); Dacheng WANG, Xianyang (CN); Lihua XU, Xianyang (CN); Zhao ZENG, Xianyang (CN); Binbin WANG, Xianyang (CN)

(73) Assignee: CAIHONG DISPLAY DEVICES CO., LTD., Xianyang (CN)

(21) Appl. No.: 18/966,039

(22) Filed: Dec. 2, 2024

Related U.S. Application Data
(63) Continuation of application No. PCT/CN2024/092904, filed on May 13, 2024.

(30) Foreign Application Priority Data
Jun. 19, 2023 (CN) 202310727160.5

(51) Int. Cl. C03C 10/00; C03B 19/02; C03B 25/02; C03B 32/02

(52) U.S. Cl. CPC C03C 10/0054; C03B 19/02; C03B 25/02; C03B 32/02; C03C 10/0027; C03C 2204/00

(57) ABSTRACT

Disclosed is a high-hardness electronic glass and its preparation method. Raw materials of the high-hardness electronic glass include components, by a mass percentage, consisting of: 58.3%-62.93% of SiO₂, 23.02%-25.94% of Al₂O₃, 1.95%-5.02% of B₂O₃, 2.07%-4.21% of Li₂O, 0%-2.88% of Na₂O, 0%-2.29% of K₂O, 0%-3.30% of TiO₂, 0%-3.99% of ZrO₂, and 0%-4.17% of P₂O₅, and a sum of the mass percentages of the components is 100%.

### CROSS-REFERENCE TO RELATED APPLICATIONS

This application is a Continuation of International Application No. PCT/CN2024/092904, filed on May 13, 2024, which claims priority to Chinese Patent Application No. 202310727160.5, filed on Jun. 19, 2023, the entire contents of each of which are hereby incorporated by reference.

### TECHNICAL FIELD

The present disclosure relates to the field of electronic glass, and in particular, to a high-hardness electronic glass and its preparation method.

### BACKGROUND

A front touch screen of a mobile electronic display device such as a cell phone and a personal digital assistant (PDA) usually includes protective cover glass, while the back cover usually consists of materials such as glass, plastic, metal, and glass ceramics. With the popularization of 5G, the back cover of 5G cell phones is gradually replaced by the glass due to the obvious absorption of 5G high-frequency signals by metallic materials, and the glass can be applied to the front and back covers of the mobile electronic display devices for protection. Due to frequent contact, the used cover glass must have good impact and scratch resistance. Currently, the chemically strengthened high alumina silicate cover glass, when used, comes into contact with hard objects such as keys, resulting in scratches on the surface and minor damage, which not only shortens the service life of the device but also increases the maintenance cost. Therefore, there is a need to develop a microcrystalline glass and its products that have drop resistance, pressure resistance, scratch resistance, and high transmittance.

The glass, as a brittle material, contains many Griffith cracks. Although a surface compressive stress layer produced by chemical strengthening plays a certain role in blocking the cracks, if the cracks extend beyond the depth of the compressive stress layer, there is no blocking effect on the crack extension. However, in the microcrystalline glass that has both a crystalline phase and a glassy phase, the crystalline phase can prevent the cracks from extending, thereby increasing scratch resistance and crack resistance of the glass, while the crystalline phase also affects the transparency of the glass. Therefore, there is an urgent need to develop an electronic glass with high transmittance and high hardness to meet the performance requirements of the front and back protective materials of the mobile electronic display devices.

### SUMMARY

One or more embodiments of the present disclosure provide a high-hardness electronic glass, wherein raw materials of the high-hardness electronic glass comprises components, by a mass percentage, consisting of: 58.3%-62.93% of SiO₂, 23.02%-25.94% of Al₂O₃, 1.95%-5.02% of B₂O₃, 2.07%-4.21% of Li₂O, 0%-2.88% of Na₂O, 0%-2.29% of K₂O, 0%-3.30% of TiO₂, 0%-3.99% of ZrO₂, and 0%-4.17% of P₂O₅, wherein a sum of the mass percentages of the components is 100%.

In some embodiments, a Vickers hardness value of the high-hardness electronic glass is within a range of 580-680 kgf/mm².

One or more embodiments of the present disclosure provide a preparation method for the high-hardness electronic glass as described above, comprising: S1, obtaining a molded glass block by mixing the raw materials of the high-hardness electronic glass for melting, pouring and molding, and performing an annealing treatment; S2, obtaining a base glass sheet by slicing the molded glass block, grinding, and polishing; and S3, obtaining the high-hardness electronic glass containing a crystalline phase and a glassy phase by performing a heat treatment on the base glass sheet.

In some embodiments, in the S1, a process of the melting includes: heating the raw materials to a first set temperature at a first heating rate and holding for a first set time; then heating to a second set temperature at a second heating rate and holding for a second set time; and then heating to a third set temperature at a third heating rate and holding for a third set time; wherein the first heating rate is within a range of 10-15° C./min, the first set temperature is within a range of 1000-1100° C., the first set time is within a range of 30-45 min; the second heating rate is within a range of 5-7° C./min, the second set temperature is within a range of 1350-1400° C., the second set time is within a range of 1-2 h; and the third heating rate is within a range of 5-8° C./min, the third set temperature is within a range of 1645-1650° C., and the third set time is within a range of 4-5 h.

In some embodiments, in the S1, a temperature of the annealing treatment is within a range of 600-650° C.

In some embodiments, in the S2, a Vickers hardness value of the base glass sheet is within a range of 550-610 kgf/mm².

In some embodiments, in the S2, an average transmittance of the base glass sheet in a visible light range is greater than 85%.

In some embodiments, in the S3, the crystalline phase includes one or more of lithium silicate, lithium titanate, lithium aluminum silicate, or mullite.

In some embodiments, in the S3, the heat treatment includes a nucleation treatment followed by a crystallization treatment; wherein a temperature of the nucleation treatment is within a range of 750-780° C., a time of the nucleation treatment is within a range of 0.5-1 h; and a temperature of the crystallization treatment is within a range of 850-880° C., and a time of the crystallization treatment is within a range of 0.5-1 h.

### DETAILED DESCRIPTION

In order to enable those skilled in the art to understand features and effects of the present disclosure, the following are only general descriptions and definitions of terms and phrases mentioned in the present disclosure and claims. Unless otherwise indicated, all technical and scientific terms used in the text are used in the ordinary sense in which they would be understood by a person of skill in the art in the context of the present disclosure, and where there is a conflict, the definitions in the present disclosure shall prevail.

None of the theories or mechanisms described and disclosed herein, rightly or wrongly, should in any way limit the scope of the present disclosure, i.e., the contents of the present disclosure can be implemented without being limited by any particular theory or mechanism.

In the present disclosure, all characteristics such as numerical values, quantities, contents, and concentrations defined as numerical ranges or percentage ranges are for the sake of brevity and convenience only. Accordingly, the description of numerical or percentage ranges should be considered as covering and specifically disclosing all possible sub-ranges and individual values within the range (including integers and fractions).

In the present disclosure, unless otherwise noted, the terms “contain”, “include”, “has”, or similar terms cover meanings “consists of” and “is mainly composed of”, e.g. “A contains a” covers the meanings “A includes a and others” and “A consists of a”.

In the present disclosure, all possible combinations of each technical feature in each embodiment are not described for the sake of brevity of description. Thus, as long as there is no contradiction in the combinations of these technical features, the various technical features in the various embodiments can be combined in any combination, and all possible combinations should be considered to be within the scope of the present disclosure as recorded herein.

The present disclosure is further elaborated below in connection with specific embodiments. It should be understood that these embodiments are used only to illustrate the present disclosure and are not intended to limit the scope of the present disclosure. It should also be understood that after reading what is taught in the present disclosure, those skilled in the art can make various changes or modifications to the present disclosure, and that these equivalent forms likewise fall within the scope of the present disclosure as defined by the appended claims.

The following embodiments use conventional instrumentation in the art. The experimental methods in the following embodiments for which specific conditions are not noted are generally in accordance with conventional conditions, or in accordance with conditions recommended by the manufacturer. The used various raw materials in following embodiments, unless otherwise indicated, are conventional commercially available products with specifications that are conventional in the art. In the present disclosure and in the following embodiments, unless otherwise indicated, “%” denotes a mass percentage, “part” denotes a mass part, and “proportion” denotes a mass ratio.

Embodiments of the present disclosure provide a high-hardness electronic glass and its preparation method. The high transmittance and high-hardness electronic glass is obtained by performing post-processing on the firstly prepared high transmittance base glass to produce a second phase capable of blocking the crack expansion to enhance the glass hardness.

Embodiments of the present disclosure provide a high-hardness electronic glass, and raw materials of the high-hardness electronic glass comprises components, by a mass percentage, consisting of: 58.3%-62.93% of SiO₂, 23.02%-25.94% of Al₂O₃, 1.95%-5.02% of B₂O₃, 2.07%-4.21% of Li₂O, 0%-2.88% of Na₂O, 0%-2.29% of K₂O, 0%-3.30% of TiO₂, 0%-3.99% of ZrO₂, and 0%-4.17% of P₂O₅, wherein a sum of the mass percentages of the components is 100%.

The SiO₂ is a network-former in glass, forming an irregular and continuous network in a structure of silica-oxygen tetrahedra [SiO₄], which constitutes a glass framework. The SiO₂ reduces coefficient of thermal expansion of the glass, minimizing a difference between the coefficients of thermal expansion of the glass and the second phase. However, when a content of SiO₂ is too high, high-temperature viscosity of the glass increases, which is easy to form a silicon-rich phase inducing the generation of the second phase. In some embodiments, the content of SiO₂ is controlled to be within a range of 58.3%-62.93%, and the glass has a low coefficient of thermal expansion.

The Al₂O₃ is an intermediate oxide. When there are insufficient oxygen atoms in the glass, a coordination state of aluminum is aluminum-oxygen octahedron [AlO₆], which is located in a network gap; when there are excess oxygen atoms in the glass, the coordination state of aluminum is aluminum-oxygen tetrahedron [AlO₄], which integrates into the glass structure to complement the network, increasing stability of the glass, reducing the coefficient of thermal expansion, and enhancing hardness of the glass. However, when a content of the Al₂O₃ is too high, a viscosity of the base glass tends to increase, and the molding performance deteriorates. In some embodiments, the content of Al₂O₃ is controlled to be within a range of 23.02%-25.94%, and the glass has a stable structure, a low coefficient of thermal expansion, and a high surface hardness.

The B₂O₃ reduces the viscosity of the glass at the high temperature and has a fluxing effect. But when a content of the B₂O₃ is too high, the coefficient of thermal expansion of the glass increases and the hardness of the surface of the base glass reduces. In some embodiments, the content of B₂O₃ is controlled to be within a range of 1.95%-5.02%, which has a fluxing effect without affecting the thermal stability and the surface hardness of the glass.

The Li₂O is an alkali metal oxide and an important constituent for the formation of the second phase in the base glass, which is capable of reducing a melting temperature of the glass and improving moldability. However, when a content of Li₂O is too high, exceeding 5%, the stability of the glass becomes poor, and the precipitation of the second phase is not well controlled, leading to devitrification of the glass. In some embodiments, the content of Li₂O is controlled to be within a range of 2.07%-4.21%, which has a fluxing effect, without affecting the stability of the glass, and facilitating the control of the emergence and size of the second phase.

The Na₂O and the K₂O are alkali metal oxides, which serve as effective fluxes in the glass component, lowering the glass melting temperature and improving moldability. The Na₂O and the K₂O are also essential components for the chemical strengthening of electronic glass to enhance surface strength. However, if the contents of the Na₂O and K₂O are too high, the stability of the glass reduces. In some embodiments, the content of Na₂O is controlled to be within a range of 0%-2.88%, and the content of K₂O is controlled to be within a range of 0%-2.29%.

The P₂O₅ has a network-complementing effect and a phase-separation effect in the glass. The network-complementing effect is that the formed phosphorus-oxygen tetrahedra [PO₄] in the glass by P₂O₅ combines with the aluminum-oxygen tetrahedra [AlO₄] to integrate into the silica-oxygen network for network-complementing, thus increasing structural stability and inhibiting glass phase separation. The phase-separation effect is that the high coordination number of phosphide and a strong field strength of P⁵⁺ can disrupt the structure of the silica-oxygen tetrahedra to seize O²⁻ to form tetrahedra, during the heat treatment, P₂O₅ can separate from the silicate network to promote phase separation; and during this phase separation process, an increase in temperature leads to enrichment of glass components to further promote crystallization. In some embodiments, the content of P₂O₅ is within a range of 0%-4.17%, whether the network-complementing effect or the phase-separation effect plays a dominant role is related to the content of the other components in the glass.

The ZrO₂ is a good nucleating agent for glass. The field strength of Zr⁴⁺ is relatively high, and surrounding O²⁻ is arranged according to the coordination number of Zr⁴⁺, which is “accumulation”. After seizing free oxygen in the structure, the “accumulation” continues to seize the bridging oxygen in the glass framework, which causes O²⁻ of the Si—O bond to be more biased towards Zr⁴⁺, forming Si—O—Zr—O—Si, and leading to accumulation that can result in phase separation or crystallization after a suitable heat treatment. While the ZrO₂ aids in enhancing the chemical durability and the hardness of the glass, an excessive high content of ZrO₂ increases the difficulty of melting the glass and makes it challenging to control a size of the second phase. In some embodiments, the content of ZrO₂ is controlled to be within a range of 0%-3.99%.

The TiO₂ is also an effective nucleating agent for the glass. At the high temperature, the TiO₂ has a high solubility in the glass melt, Ti⁴⁺ participates in the silica-oxygen network in a tetrahedral coordination and has considerable compatibility with the silica-oxygen tetrahedra of framework structure of the glass; however, due to the strong field of the Ti⁴⁺, upon cooling or reheating, the TiO₂ tends to aggregate into titanium-containing droplets, promoting glass phase separation. But the content of TiO₂ may not be too high because the Ti⁴⁺ valence electrons transition between different energy levels can cause selective absorption of visible light, resulting in a yellow color of the glass. In some embodiments, the content of TiO₂ is controlled to be within a range of 0%-3.30%.

Through an adjustment of the above component content, the produced glass exhibits high transparency and surface hardness, a controllable second phase is generated after the heat treatment, which prevents the extension of cracks and increases the hardness of the glass.

A Vickers hardness value of the glass is used to illustrate ability of the glass to resist indentation deformation, i.e., the ability of the glass to resist permanent deformation when subjected to an external force. A Vickers hardness test for the glass is a method for evaluating the hardness of the glass by applying a certain pressure to the surface of the glass and measuring a size of the indentation.

In some embodiments, a Vickers hardness value of the high-hardness electronic glass is within a range of 580-680 kgf/mm².

In some embodiments, the Vickers hardness value of the high-hardness electronic glass is 580 kgf/mm², 600 kgf/mm², 620 kgf/mm², 640 kgf/mm², 660 kgf/mm², 680 kgf/mm², or the like.

In some embodiments, the Vickers hardness value of the high-hardness electronic glass is 594 kgf/mm², 613 kgf/mm², 630 kgf/mm², or 644 kgf/mm².

One or more embodiments of the present disclosure also provide a preparation method for the high-hardness electronic glass, comprising following operations.
S1: obtaining a molded glass block by mixing the raw materials of the high-hardness electronic glass for melting, pouring and molding, and performing an annealing treatment;
S2: obtaining a base glass sheet by slicing the molded glass block, grinding, and polishing; and
S3: obtaining the high-hardness electronic glass containing a crystalline phase and a glassy phase by performing a heat treatment on the base glass sheet.

In some embodiments, in the S1, a process of the melting includes: heating the raw materials to a first set temperature at a first heating rate and holding for a first set time; then heating to a second set temperature at a second heating rate and holding for a second set time; and then heating to a third set temperature at a third heating rate and holding for a third set time.

In some embodiments, the first heating rate is within a range of 10-15° C./min, the first set temperature is within a range of 1000-1100° C., the first set time is within a range of 30-45 min; the second heating rate is within a range of 5-7° C./min, the second set temperature is within a range of 1350-1400° C., the second set time is within a range of 1-2 h; and the third heating rate is within a range of 5-8° C./min, the third set temperature is within a range of 1645-1650° C., the third set time is within a range of 4-5 h.

In some embodiments, in the S1, the process of the melting includes heating the raw materials to 1000-1100° C. at 10-15° C./min and holding for 30-45 min; then heating to 1350-1400° C. at 5-7° C./min and holding for 1-2 h; and then heating to 1645-1650° C. at 5-8° C./min and holding for 4-5 h.

In some embodiments, in the S1, a temperature of the annealing treatment is within a range of 600-650° C.

In some embodiments, in the S1, the temperature of the annealing treatment is 600° C., 610° C., 620° C., 630° C., 640° C., 650° C., or the like.

In some embodiments, a Vickers hardness value of the base glass sheet is within a range of 550-610 kgf/mm².

In some embodiments, in the S2, the Vickers hardness value of the base glass sheet is 550 kgf/mm², 560 kgf/mm², 570 kgf/mm², 580 kgf/mm², 590 kgf/mm², 600 kgf/mm², 610 kgf/mm², or the like.

In some embodiments, in the S2, the Vickers hardness value of the base glass sheet is 550 kgf/mm², 557 kgf/mm², 564 kgf/mm², 572 kgf/mm², 581 kgf/mm², 587 kgf/mm², or 601 kgf/mm².

In some embodiments, in the S2, an average transmittance of the base glass sheet in a visible light range is greater than 85%. The average transmittance of the base glass sheet in the visible light range reflects the transmittance properties of the base glass sheet for the visible light.

In some embodiments, in the S2, the average transmittance of the base glass sheet in the visible light range is 85%, 87%, 89%, 91%, or the like.

In some embodiments, in the S2, the average transmittance of the base glass sheet in the visible light range is 85.2%, 86.8%, 87.6%, 88.4%, 89.2%, 89.5%, 90.3%, or 91.0%.

In some embodiments, in the S3, the crystalline phase includes one or more of lithium silicate, lithium titanate, lithium aluminum silicate, or mullite.

In some embodiments, in the S3, the heat treatment includes a nucleation treatment followed by a crystallization treatment.

The nucleation treatment is the formation of a large number of crystal nucleus in the base glass sheet. In some embodiments, the nucleation treatment is achieved by a change in the concentration of the solution caused by a change in temperature. When the concentration change in the solution reaches a certain nucleation requirement, crystal nucleus begin to form.

The crystallization treatment is carried out after the nucleation treatment so that the crystal nucleus that have been formed continue to grow and eventually form a stable crystal structure.

In some embodiments, a temperature of the nucleation treatment is within a range of 750-780° C. In some embodiments, the temperature of the nucleation treatment is 750° C., 760° C., 770° C., 780° C., or the like.

In some embodiments, a time of the nucleation treatment is within a range of 0.5-1 h. In some embodiments, the time of the nucleation treatment is 0.5 h, 0.6 h, 0.7 h, 0.8 h, 0.9 h, 1 h, or the like.

In some embodiments, a temperature of the crystallization treatment is within a range of 850-880° C. In some embodiments, the temperature of the crystallization treatment is 850° C., 860° C., 870° C., 880° C., or the like.

In some embodiments, a time of the crystallization treatment is within a range of 0.5-1 h. In some embodiments, the time of the crystallization treatment is 0.5 h, 0.6 h, 0.7 h, 0.8 h, 0.9 h, 1 h, or the like.

In some embodiments, the heat treatment includes the nucleation treatment for 0.5-1 h at 750-780° C., and the crystallization treatment for 0.5-1 h at 850-880° C.

In some embodiments, the preparation method for the high-hardness electronic glass comprises follow operations.
a) Calculating weights of required raw materials by mass percentages of oxides and weighing accurately.
(b) Mixing the weighed raw materials evenly in a mixer, pouring the mixed raw materials into a platinum crucible, and putting the platinum crucible into a high-temperature experimental furnace, heating to 1000° C. at a rate of 10° C./min and holding for 30 min; then heating to 1350° C. at a rate of 5° C./min and holding for 1 h; then heating to 1650° C. at a rate of 5° C./min and holding for 4 h to form glass melt; pouring the glass melt into a preheated mold to form a glass block with a regular shape, and putting the glass block into an annealing furnace that has been heated to 600° C., and cooling down to a room temperature in the annealing furnace.
(c) slicing the annealed glass block into glass slices with a thickness of 1.3 mm using a wire cutting machine, and ultrasonically cleaning the glass slices with the thickness of 1.3 mm using alcohol and pure water in turn, and drying in an oven at 105° C. Afterwards, grinding the dried glass slices on a grinder using vacuum adsorption, and obtaining the glass slices with an average thickness of 1.1 mm by measuring the thickness of the glass slices using a spiral micrometer. After washing and drying, polishing the glass slices on a polishing machine using vacuum adsorption, and obtaining the glass slices with an average thickness of 1.0 mm by measuring the thickness of the glass slices using the spiral micrometer, and obtaining a transparent base glass sheet after washing and drying.
(d) Based on an expansion softening point and a glass transition temperature of the base glass, setting an appropriate nucleation process and crystallization process, and putting the base glass sheet into the annealing furnace and performing the heat treatment according to the set process to obtain the high-hardness electronic glass containing the crystalline phase and glassy phase.

In some embodiments of the present disclosure, according to the preparation method for the high-hardness electronic glass, the base glass has a high transmittance, has a smooth and transparent surface by grinding and polishing, and produces a second phase (i.e., the crystalline phase) different from the glassy phase after the heat treatment, which can block the further crack expansion to improve the hardness of the glass.

### EXAMPLE

### Example 1

A preparation method for a high-hardness electronic glass, comprising:

(1) The high-hardness electronic glass comprises components, by a mass percentage, consisting of: 59.62% of SiO₂, 24.58% of Al₂O₃, 1.95% of B₂O₃, 2.12% of Li₂O, 2.88% of Na₂O, 1.83% of K₂O, 0% of TiO₂, 3.99% of ZrO₂, and 3.03% of P₂O₅. The weights of the required raw materials were calculated and the raw materials were weighed accurately.

(2) The weighed raw materials were mixed evenly in a mixer, the mixed raw materials were poured into a platinum crucible, and the platinum crucible was put into a high-temperature experimental furnace, the platinum crucible was heated to 1000° C. at a rate of 10° C./min and holding for 30 min; then heated to 1350° C. at a rate of 5° C./min and holding for 1 h; and then heated to 1650° C. at a rate of 5° C./min and holding for 4 h to form a glass melt. The glass melt was poured into a preheated mold to form a glass block with a regular shape, and the glass block was put into an annealing furnace that has been heated to 600° C., and cooled down to a room temperature in the annealing furnace.

(3) The annealed glass block was sliced into glass slices with a thickness of 1.3 mm on a wire cutting machine, and the glass slices with the thickness of 1.3 mm were ultrasonically cleaned using alcohol and pure water in turn, and dried in an oven at 105° C. Afterwards, the dried glass slices were ground on a grinder using vacuum adsorption, and the glass slices with an average thickness of 1.1 mm were obtained by measuring a thickness of the glass slices using a spiral micrometer. After washing and drying, the glass slices were polished on a polishing machine using vacuum adsorption, and the glass slices with the average thickness of 1.0 mm was obtained by measuring the thickness of the glass slices using a spiral micrometer, and a transparent base glass sheet was obtained after washing and drying.

(4) The base glass sheet was put into a dilatometer to obtain a base glass, and a glass transition temperature of the base glass was measured to be 706° C., an expansion softening point of the base glass was measured to be 823° C., and a coefficient of thermal expansion of the base glass from 30° C. to 380° C. was measured to be 35.8×10⁻⁷/° C. A density of the base glass was measured to be 2.392 g/cm³ by a densitometer. A transmittance at visible wavelengths was measured by a haze meter, and an average transmittance of the base glass in a visible light range was 90.3%. A Vickers hardness value of the base glass was measured to be 572 kgf/mm² by a Vickers hardness tester.

(5) Based on the measured glass transition temperature and expansion softening point, a nucleation process was set as 780° C.-1 h and a crystallization process was set as 880° C.-1 h. The base glass sheet was then placed in the annealing furnace and heated to 780° C. at a rate of 5° C./min and holding for 1 h; then heated up to 880° C. at a rate of 5° C./min and holding for 1 h; and cooled in the annealing furnace to obtain the heat-treated glass sheet (or the glass sheet after heat treatment).

6) A Vickers hardness value of the heat-treated glass was measured to be 630 kgf/mm² using the Vickers hardness tester, and the heat-treated glass was ground into a powder, which was identified to contain other phase (i.e., lithium silicate and lithium aluminum silicate) different from the glassy phase using X-ray Diffraction (XRD).

### Example 2

A preparation method for a high-hardness electronic glass, comprising:

(1) The high-hardness electronic glass comprises components, by a mass percentage, consisting of: 60.69% of SiO₂, 23.02% of Al₂O₃, 5.02% of B₂O₃, 2.16% of Li₂O, 1.89% of Na₂O, 0.36% of K₂O, 3.30% of TiO₂, 3.56% of ZrO₂, and 0% of P₂O₅. The weights of the required raw materials were calculated and the raw materials were weighed accurately.

(2) The weighed raw materials were mixed evenly in the mixer, the mixed raw materials were poured into the platinum crucible, and the platinum crucible was put into the high-temperature experimental furnace, the platinum crucible was heated to 1000° C. at a rate of 10° C./min and holding for 30 min; then heated to 1350° C. at a rate of 5° C./min and holding for 1 h; and then heated to 1650° C. at a rate of 5° C./min and holding for 4 h to form a glass melt. The glass melt was poured into the preheated mold to form a glass block with a regular shape, and the glass block was put into the annealing furnace that has been heated up to 600° C., and cooled down to the room temperature in the annealing furnace.

(3) The annealed glass block was sliced into glass slices with a thickness of 1.3 mm on the wire cutting machine, and the glass slices with the thickness of 1.3 mm were ultrasonically cleaned using alcohol and pure water in turn, and dried in the oven at 105° C. Afterwards, the dried glass sheet was ground on the grinder using vacuum adsorption, and the glass slices with the average thickness of was 1.1 mm by measuring the thickness of the glass slices by the spiral micrometer. After washing and drying, the glass slices were polished on the polishing machine using vacuum adsorption, and the glass slices with the average thickness of 1.0 mm were obtained by measuring the thickness of the glass slices using the spiral micrometer, and a transparent base glass sheet was obtained after washing and drying.

(4) The base glass sheet was put into the dilatometer to obtain the base glass, and the glass transition temperature of the base glass was measured to be 697° C., the expansion softening point of the base glass was measured to be 810° C., and the coefficient of thermal expansion of the base glass from 30° C. to 380° C. was measured to be 36.1×10⁻⁷/° C. A density of the base glass was measured to be 2.432 g/cm³ using the densitometer. The transmittance at the visible wavelengths was measured by the haze meter, and the average transmittance of the base glass in the visible light range was 85.2%. A Vickers hardness value of the base glass was measured to be 610 kgf/mm² using the Vickers hardness tester.

(5) Based on the measured glass transition temperature and expansion softening point, the nucleation process was set as 760° C.-1 h and the crystallization process was set as 860° C.-1 h. The base glass sheet was then placed in the annealing furnace, heated to 760° C. at a rate of 5° C./min and holding for 1 h, then heated to 860° C. at a rate of 5° C./min and holding for 1 h, and cooled in the annealing furnace to obtain the heat-treated glass sheet.

(6) A Vickers hardness value of the heat-treated glass was measured to be 680 kgf/mm² using the Vickers hardness tester, and the glass was ground into a powder, which was identified to contain other phase (i.e., lithium titanate) different from the glassy phase using XRD.

### Example 3

A preparation method for a high-hardness electronic glass, comprising:

(1) The high-hardness electronic glass comprises components, by a mass percentage, consisting of: 62.12% of SiO₂, 24.61% of Al₂O₃, 3.11% of B₂O₃, 4.21% of Li₂O, 0.92% of Na₂O, 1.39% of K₂O, 0% of TiO₂, 3.64% of ZrO₂, and 0% of P₂O₅. The weights of the required raw materials were calculated and the raw materials were weighed accurately.

(2) The weighed raw materials were mixed evenly in the mixer, the mixed raw materials were poured into the platinum crucible, and the platinum crucible was put into the high-temperature experimental furnace, the platinum crucible was heated to 1000° C. at a rate of 10° C./min and holding for 30 min; then heated to 1350° C. at a rate of 5° C./min and holding for 1 h; and then heated to 1650° C. at a rate of 5° C./min and holding for 4 h to form a glass melt. The glass melt was poured into the preheated mold to form a glass block with a regular shape, and the glass block was put into the annealing furnace that has been heated up to 600° C., and cooled down to the room temperature in the annealing furnace.

(3) The annealed glass block was sliced into glass slices with a thickness of 1.3 mm on the wire cutting machine, and the glass slices with the thickness of 1.3 mm were ultrasonically cleaned using alcohol and pure water in turn, and dried in the oven at 105° C. Afterwards, the dried glass slices were ground on the grinder using vacuum adsorption, and the glass slices with the average thickness of 1.1 mm were obtained by measuring the thickness of the glass slices using the spiral micrometer. After washing and drying, the glass slices were polished on the polishing machine using vacuum adsorption, and the glass slices with the average thickness of 1.0 mm were obtained by measuring the thickness of the glass slices using the spiral micrometer, and a transparent base glass sheet was obtained after washing and drying.

(4) The base glass sheet was put into the dilatometer to obtain the base glass, and the glass transition temperature of the base glass was measured to be 701° C., the expansion softening point of the base glass was measured to be 805° C., and the coefficient of thermal expansion of the base glass from 30° C. to 380° C. was measured to be 36.2×10⁻⁷/° C. A density of the base glass was measured to be 2.415 g/cm³ using the densitometer. The transmittance at the visible wavelengths was measured by the haze meter, and the average transmittance of the base glass in the visible light range was 89.2%. A Vickers hardness value of the base glass was measured to be 601 kgf/mm² using the Vickers hardness tester.

(5) Based on the measured glass transition temperature and expansion softening point, the nucleation process was set as 770° C.-1 h and the crystallization process was set as 870° C.-1 h. The base glass sheet was then placed in the annealing furnace, heated to 770° C. at a rate of 5° C./min and holding for 1 h, and then heated to 870° C. at a rate of 5° C./min and holding for 1 h, and cooled in the furnace to obtain the heat-treated glass sheet.

6) A Vickers hardness value of the heat-treated glass was measured to be 660 kgf/mm² using the Vickers hardness tester, and the glass was ground into a powder, which was identified to contain other phase (i.e., mullite) different from the glassy phase using XRD.

### Example 4

A preparation method for a high-hardness electronic glass, comprising:

(1) The high-hardness electronic glass comprises components, by a mass percentage, consisting of: 60.36% of SiO₂, 23.88% of Al₂O₃, 4.0% of B₂O₃, 3.15% of Li₂O, 1.59% of Na₂O, 1.95% of K₂O, 2.99% of TiO₂, 0% of ZrO₂, and 2.08% of P₂O₅. The weights of the required raw materials were calculated and the raw materials were weighed accurately.

(2) The weighed raw materials were mixed evenly in the mixer, the mixed raw materials were poured into the platinum crucible, and the platinum crucible was put into the high-temperature experimental furnace, the platinum crucible was heated to 1000° C. at a rate of 10° C./min and holding for 30 min; then heated to 1350° C. at a rate of 5° C./min and holding for 1 h; and then heated to 1650° C. at a rate of 5° C./min and holding for 4 h to form a glass melt. The glass melt was poured into the preheated mold to form a glass block with a regular shape, and the glass block was put into the annealing furnace that has been heated up to 600° C., and cooled down to the room temperature in the annealing furnace.

(3) The annealed glass block was sliced into glass slices with a thickness of 1.3 mm on the wire cutting machine, and the glass slices with the thickness of 1.3 mm were ultrasonically cleaned using alcohol and pure water in turn, and dried in the oven at 105° C. Afterwards, the dried glass slices were ground on the grinder using vacuum adsorption, and the glass slices with the average thickness of 1.1 mm were obtained by measuring the thickness of the glass slices using the spiral micrometer. After washing and drying, the glass slices were polished on the polishing machine using vacuum adsorption, and the glass slices with the average thickness of 1.0 mm were obtained by measuring the thickness of the glass slices using the spiral micrometer, and a transparent base glass sheet was obtained after washing and drying.

(4) The base glass sheet was put into the dilatometer to obtain the base glass, and the glass transition temperature of the base glass was measured to be 688° C., the expansion softening point of the base glass was measured to be 775° C., and the coefficient of thermal expansion of the base glass from 30° C. to 380° C. was measured to be 34.8×10⁻⁷/° C. A density of the base glass was measured to be 2.355 g/cm³ using the densitometer. The transmittance at the visible wavelengths was measured by the haze meter, and the average transmittance of the base glass in the visible light range was 87.6%. A Vickers hardness value of the base glass was 557 kgf/mm² using the Vickers hardness tester.

(5) Based on the measured glass transition temperature and expansion softening point, the nucleation process was set as 780° C.-1 h and the crystallization process was set as 880° C.-1 h. The base glass sheet was then placed in the annealing furnace, heated to 780° C. at a rate of 5° C./min and holding for 1 h, and then heated to 880° C. at a rate of 5° C./min and holding for 1 h, and cooled in the furnace to obtain the heat-treated glass sheet.

6) A Vickers hardness value of the heat-treated glass was measured to be 594 kgf/mm² using the Vickers hardness tester, and the heat-treated glass was ground into a powder, which was identified to contain other phase (i.e., lithium titanate) different from the glassy phase using XRD.

### Example 5

A preparation method for a high-hardness electronic glass, comprising:

(1) The high-hardness electronic glass comprises components, by a mass percentage, consisting of: 61.78% of SiO₂, 24.47% of Al₂O₃, 4.09% of B₂O₃, 3.2% of Li₂O, 0% of Na₂O, 2.29% of K₂O, 0% of TiO₂, 0% of ZrO₂, and 4.17% of P₂O₅. The weights of the required raw materials were calculated and the raw materials were weighed accurately.

(2) The weighed raw materials were mixed evenly in the mixer, the mixed raw materials were poured into the platinum crucible, and the platinum crucible was put into the high-temperature experimental furnace, the platinum crucible was heated to 1000° C. at a rate of 10° C./min and holding for 30 min; then heated to 1350° C. at a rate of 5° C./min and holding for 1 h; and then heated to 1650° C. at a rate of 5° C./min and holding for 4 h to form a glass melt. The glass melt was poured into the preheated mold to form a glass block with a regular shape, and the glass block was put into the annealing furnace that has been heated up to 600° C. and cooled down to the room temperature in the annealing furnace.

(3) The annealed glass block was sliced into glass slices with a thickness of 1.3 mm on a wire cutting machine, and the glass slices with the thickness of 1.3 mm were ultrasonically cleaned using alcohol and pure water in turn, and dried in the oven at 105° C. Afterwards, the dried glass slices were ground on the grinder using vacuum adsorption, and the glass slices with the average thickness of 1.1 mm were obtained by measuring the thickness of the glass slices using the spiral micrometer. After washing and drying, the glass slices were polished on the polishing machine using vacuum adsorption, and the glass slices with the average thickness of 1.0 mm were obtained by measuring the thickness of the glass slices using the spiral micrometer, and a transparent base glass sheet was obtained after washing and drying.

(4) The base glass sheet was put into the dilatometer to obtain the base glass, and the glass transition temperature of the base glass was measured to be 684° C., the expansion softening point of the base glass was measured to be 780° C., and the coefficient of thermal expansion of the base glass from 30° C. to 380° C. was measured to be 35.2×10⁻⁷/° C. A density of the base glass was measured to be 2.336 g/cm³ using the densitometer. The transmittance at the visible wavelengths was measured by the haze meter, and the average transmittance of the base glass in the visible light range was 91.0%. A Vickers hardness value of the base glass was 550 kgf/mm² using the Vickers hardness tester.

(5) Based on the measured glass transition temperature and expansion softening point, the nucleation process was set as 780° C.-1 h and the crystallization process was set as 880° C.-1 h. The base glass sheet was then placed in the annealing furnace, heated to 780° C. at a rate of 5° C./min and holding for 1 h, and then heated to 880° C. at a rate of 5° C./min and holding for 1 h, and cooled in the furnace to obtain the heat-treated glass sheet.

6) A Vickers hardness value of the heat-treated glass was measured to be 580 kgf/mm² using the Vickers hardness tester, and the glass was ground into a powder, which was identified to contain other phase (i.e., lithium silicate) different from the glassy phase using XRD.

### Example 6

A preparation method for a high-hardness electronic glass, comprising:

(1) The high-hardness electronic glass comprises components, by a mass percentage, consisting of: 58.3% of SiO₂, 24.03% of Al₂O₃, 3.86% of B₂O₃, 2.07% of Li₂O, 0.86% of Na₂O, 1.31% of K₂O, 2.21% of TiO₂, 3.42% of ZrO₂, and 3.94% of P₂O₅. The weights of the required raw materials were calculated and the raw materials were weighed accurately.

(2) The weighed raw materials were mixed evenly in the mixer, the mixed raw materials were poured into the platinum crucible, and the platinum crucible was put into the high-temperature experimental furnace, the platinum crucible was heated to 1000° C. at a rate of 10° C./min and holding for 30 min; then heated to 1350° C. at a rate of 5° C./min and holding for 1 h; and then heated up to 1650° C. at a rate of 5° C./min and holding for 4 h to form a glass melt. The glass melt was poured into the preheated mold to form a glass block with a regular shape, and the glass block was put into the annealing furnace that has been heated up to 600° C., and cooled down to the room temperature in the annealing furnace.

(3) The annealed glass block was sliced into glass slices with a thickness of 1.3 mm on the wire cutting machine, and the glass slices with the thickness of 1.3 mm were ultrasonically cleaned using alcohol and pure water in turn, and dried in the oven at 105° C. Afterwards, the dried glass slices were ground on the grinder using vacuum adsorption, and the glass slices with the average thickness of 1.1 mm were obtained by measuring the thickness of the glass slices using the spiral micrometer. After washing and drying, the glass slices were polished on the polishing machine using vacuum adsorption, and the glass slices with the average thickness of 1.0 mm were obtained by measuring the thickness of the glass slices using the spiral micrometer, and a transparent base glass sheet was obtained after washing and drying.

(4) The base glass sheet was put into the dilatometer to obtain the base glass, and the glass transition temperature of the base glass was measured to be 703° C., the expansion softening point of the base glass was measured to be 795° C., and the coefficient of thermal expansion of the base glass from 30° C. to 380° C. was measured to be 35.7×10⁻⁷/° C. A density of the base glass was measured to be 2.410 g/cm³ using the densitometer. The transmittance at the visible wavelengths was measured by the haze meter, and the average transmittance of the base glass in the visible light range was 86.8%. A Vickers hardness value of the base glass was measured to be 564 kgf/mm² using the Vickers hardness tester.

(5) Based on the measured glass transition temperature and expansion softening point, the nucleation process was set as 780° C.-1 h and the crystallization process was set as 880° C.-1 h. The base glass sheet was then placed in the annealing furnace, heated to 780° C. at a rate of 5° C./min and holding for 1 h, and then heated to 880° C. at a rate of 5° C./min and holding for 1 h, and cooled in the furnace to obtain the heat-treated glass sheet.

6) A Vickers hardness value of the heat-treated glass was measured to be 613 kgf/mm² using the Vickers hardness tester, and the glass was ground into a powder, which was identified to contain other phase (i.e., lithium titanate) different from the glassy phase using XRD.

### Example 7

A preparation method for a high-hardness electronic glass, comprising:

(1) The high-hardness electronic glass comprises components, by a mass percentage, consisting of: 62.93% of SiO₂, 25.94% of Al₂O₃, 4.17% of B₂O₃, 2.24% of Li₂O, 2.34% of Na₂O, 0% of K₂O, 2.38% of TiO₂, 0% of ZrO₂, and 0% of P₂O₅. The weights of the required raw materials were calculated and the raw materials were weighed accurately.

(2) The weighed raw materials were mixed evenly in the mixer, the mixed raw materials were poured into the platinum crucible, and the platinum crucible was put into the high-temperature experimental furnace, the platinum crucible was heated to 1000° C. at a rate of 10° C./min and holding for 30 min; then heated to 1350° C. at a rate of 5° C./min and holding for 1 h; and then heated to 1650° C. at a rate of 5° C./min and holding for 4 h to form a glass melt. The glass melt was poured into the preheated mold to form a glass block with a regular shape, and the glass block was put into the annealing furnace that has been heated up to 600° C., and cooled down to the room temperature in the annealing furnace.

(3) The annealed glass block was sliced into glass slices with a thickness of 1.3 mm on the wire cutting machine, and the glass slices with the thickness of 1.3 mm were ultrasonically cleaned using alcohol and pure water in turn, and dried in the oven at 105° C. Afterwards, using vacuum adsorption, the dried glass slices were ground on the grinder, and the glass slices with the average thickness of 1.1 mm were obtained by measuring the thickness of the glass slices using the spiral micrometer. After washing and drying, the glass slices were polished on the polishing machine using vacuum adsorption, and the glass slices with the average thickness of 1.0 mm were obtained by measuring the thickness of the glass slices using the spiral micrometer, and a transparent base glass sheet was obtained after washing and drying.

(4) The base glass sheet was put into the dilatometer to obtain the base glass, and the glass transition temperature of the base glass was measured to be 678° C., the expansion softening point of the base glass was measured to be 794° C., and the coefficient of thermal expansion of the base glass from 30° C. to 380° C. was measured to be 35.7×10⁻⁷/° C. A density of the base glass was measured to be 2.370 g/cm³ using the densitometer. The transmittance at the visible wavelengths was measured by the haze meter, and the average transmittance of the base glass in the visible light range was 88.4%. A Vickers hardness value of the base glass was measured to be 587 kgf/mm² using the Vickers hardness tester.

(5) Based on the measured glass transition temperature and expansion softening point, the nucleation process was set as 750° C.-1 h and the crystallization process was set as 850° C.-1 h. The base glass sheet was then placed in the annealing furnace, heated to 750° C. at a rate of 5° C./min and holding for 1 h, and then heated to 850° C. at a rate of 5° C./min and holding for 1 h, and cooled in the furnace to obtain the heat-treated glass sheet.

6) A Vickers hardness value of the heat-treated glass was measured to be 644 kgf/mm² using the Vickers hardness tester, and the glass was ground into a powder, which was identified to contain other phase (i.e., lithium titanate) different from the glassy phase using XRD.

Table 1 shows the glass components, basic properties and the second phase (crystalline phase) of the high-hardness electronic glass prepared in Examples 1-7 of the present disclosure.

TABLE 1

| Component/wt % | Example 1 | Example 2 | Example 3 | Example 4 | Example 5 | Example 6 | Example 7 |
|---|---|---|---|---|---|---|---|
| SiO₂ | 59.62 | 60.69 | 62.12 | 60.36 | 61.78 | 58.3 | 62.93 |
| Al₂O₃ | 24.58 | 23.02 | 24.61 | 23.88 | 24.47 | 24.03 | 25.94 |
| Li₂O | 2.12 | 2.16 | 4.21 | 3.15 | 3.2 | 2.07 | 2.24 |
| B₂O₃ | 1.95 | 5.02 | 3.11 | 4 | 4.09 | 3.86 | 4.17 |
| P₂O₅ | 3.03 | 0 | 0 | 2.08 | 4.17 | 3.94 | 0 |
| ZrO₂ | 3.99 | 3.56 | 3.64 | 0 | 0 | 3.42 | 0 |
| Na₂O | 2.88 | 1.89 | 0.92 | 1.59 | 0 | 0.86 | 2.34 |
| K₂O | 1.83 | 0.36 | 1.39 | 1.95 | 2.29 | 1.31 | 0 |
| TiO₂ | 0 | 3.30 | 0 | 2.99 | 0 | 2.21 | 2.38 |
| Sum | 100 | 100 | 100 | 100 | 100 | 100 | 100 |
| Heat treatment | 780° | 760° | 770° | 780° | 780° | 780° | 750° |
| process | C.-1 h | C.-1 h | C.-1 h | C.-1 h | C.-1 h | C.-1 h | C.-1 h |
| | 880° | 860° | 870° | 880° | 880° | 880° | 850° |
| | C.-1 h | C.-1 h | C.-1 h | C.-1 h | C.-1 h | C.-1 h | C.-1 h |
| Second phase | Lithium | Lithium | Mullite | Lithium | Lithium | Lithium | Lithium |
| different from | silicate, | titanate | | titanate | silicate | titanate | titanate |
| glassy phase | Lithium | | | | | | |
| | aluminum | | | | | | |
| | silicate | | | | | | |
| Density | 2.392 | 2.432 | 2.415 | 2.355 | 2.336 | 2.410 | 2.370 |
| (g/cm³) | | | | | | | |
| Coefficient of | 35.8 | 36.1 | 36.2 | 34.8 | 35.2 | 35.7 | 35.7 |
| thermal | | | | | | | |
| expansion | | | | | | | |
| (×10⁻⁷/° C.) | | | | | | | |
| (30-380° C.) | | | | | | | |
| Vickers | 572 | 610 | 601 | 557 | 550 | 564 | 587 |
| hardness before | | | | | | | |
| heat treatment | | | | | | | |
| (kgf/mm²) | | | | | | | |
| Vickers | 630 | 680 | 660 | 594 | 580 | 613 | 644 |
| hardness after | | | | | | | |
| heat treatment | | | | | | | |
| (kgf/mm²) | | | | | | | |
| Average | 90.3 | 85.2 | 89.2 | 87.6 | 91.0 | 86.8 | 88.4 |
| transmittance | | | | | | | |
| of visible light | | | | | | | |
| (%) | | | | | | | |

### Example 8

A preparation method for a high-hardness electronic glass, comprising:

(1) The high-hardness electronic glass comprises components, by a mass percentage, consisting of: 59.62% of SiO₂, 24.58% of Al₂O₃, 1.95% of B₂O₃, 2.12% of Li₂O, 2.88% of Na₂O, 1.83% of K₂O, 0% of TiO₂, 3.99% of ZrO₂, and 3.03% of P₂O₅. The weights of the required raw materials were calculated and the raw materials were weighed accurately.

(2) The weighed raw materials were mixed evenly in the mixer, the mixed raw materials were poured into the platinum crucible and the platinum crucible was put into the high-temperature experimental furnace, the platinum crucible was heated to 1100° C. at a rate of 15° C./min and holding for 45 min; then heated to 1400° C. at a rate of 7° C./min and holding for 2 h; and then heated to 1645° C. at a rate of 8° C./min and holding for 5 h to form a glass melt. The glass melt was poured into the preheated mold to form a glass block with a regular shape, and the glass block was put into the annealing furnace that has been heated up to 650° C., and then cooled down to the room temperature in the annealing furnace.

(3) The annealed glass block was sliced into glass slices with a thickness of 1.3 mm on the wire cutting machine, and the glass slices with thickness of 1.3 mm were ultrasonically cleaned using alcohol and pure water in turn, and dried in the oven at 105° C. Afterwards, the dried glass sheet was ground on the grinder using vacuum adsorption, and the glass slices with the average thickness of 1.1 mm were obtained by measuring the thickness of the glass slices using the spiral micrometer. After washing and drying, the glass slices were polished on the polishing machine using vacuum adsorption, and the glass slices with the average thickness of 1.0 mm were obtained by measuring the thickness of the glass slices using the spiral micrometer, and a transparent base glass sheet was obtained after washing and drying.

(4) The base glass sheet was put into the dilatometer to obtain the base glass, and a glass transition temperature of the base glass was measured to be 710° C., an expansion softening point of the base glass was measured to be 830° C., and a coefficient of thermal expansion of the base glass from 30° C. to 380° C. was 35.6×10⁻⁷/° C. A density of the base glass was measured to be 2.398 g/cm³ using the densitometer. The transmittance at the visible wavelengths was measured by the haze meter, and the average transmittance of the base glass in the visible light range was 89.5%. A Vickers hardness value of the base glass was measured to be 581 kgf/mm² using the Vickers hardness tester.

(5) Based on the measured glass transition temperature and expansion softening point, the nucleation process was set as 780° C.-0.5 h and the crystallization process was set as 880° C.-0.5 h. The base glass sheet was then placed in the annealing furnace, heated to 780° C. at a rate of 5° C./min, holding for 0.5 h, then heated to 880° C. at a rate of 5° C./min, holding for 0.5 h, and cooled in the furnace to obtain the heat-treated glass sheet.

6) A Vickers hardness value of the heat-treated glass was measured to be 620 kgf/mm² using the Vickers hardness tester, and the glass was ground into a powder, which was identified to contain other phase (i.e., lithium aluminum silicate) different from the glassy phase using XRD.

The above content is only to illustrate the technical ideas of the present disclosure, and cannot be used to limit the scope of protection of the present disclosure. All changes made on the basis of the technical scheme proposed according to the technical ideas of the present disclosure fall within the scope of protection of the claims of the present disclosure.

The basic concepts have been described above, and it is apparent to those skilled in the art that the foregoing detailed disclosure serves only as an example and does not constitute a limitation of the present disclosure. While not expressly stated herein, various modifications, improvements, and amendments can be made to the present disclosure by those skilled in the art. Those types of modifications, improvements, and amendments are suggested in this disclosure, so those types of modifications, improvements, and amendments remain within the spirit and scope of the exemplary embodiments of the present disclosure.

Also, the present disclosure uses specific words to describe the embodiments of the present disclosure. Such as “an embodiment”, “one embodiment”, and/or “some embodiments” means a feature, structure, or characteristic associated with at least one embodiment of the present disclosure. Accordingly, it should be emphasized and noted that “one embodiment” or “an embodiment” or “an alternative embodiment” in different locations in the present disclosure do not necessarily refer to the same embodiment. In addition, certain features, structures, or characteristics in one or more embodiments of the present disclosure can be suitably combined.

Similarly, it should be noted that in order to simplify the presentation of the disclosure of the present disclosure, and thereby aid in the understanding of one or more embodiments, the foregoing descriptions of embodiments of the present disclosure sometimes combine a variety of features into a single embodiment or description thereof. However, this method of disclosure does not imply that the objects of the present disclosure require more features than those mentioned in the claims. Rather, claimed subject matter can lie in less than all features of a single foregoing disclosed embodiment.

Some embodiments use numbers to describe the number of components, attributes, and it should be understood that such numbers used in the description of the embodiments are modified in some examples by the modifiers “about,” “approximately,” or “substantially”. Unless otherwise noted, the terms “about,” “approximately,” or “roughly” indicates that a ±20% variation in the stated number is allowed. Correspondingly, in some embodiments, the numerical parameters used in the specification and claims are approximations, which can change depending on the desired characteristics of individual embodiments. In some embodiments, the numerical parameters should take into account the specified number of valid digits and employ general place-keeping. While the numerical domains and parameters used to confirm the breadth of their ranges in some embodiments of this disclosure are approximations, in specific embodiments, such values are set to be as precise as practicable.

For each patent, patent application, patent application disclosure, and other material cited in this disclosure, such as articles, books, specification sheets, publications, documents, and the like, are hereby incorporated by reference in their entirety into this disclosure. Application history documents that are inconsistent with or conflict with the contents of this disclosure are excluded, as are documents (currently or hereafter appended to this disclosure) that limit the broadest scope of the claims of this disclosure. It should be noted that in the event of any inconsistency or conflict between the descriptions, definitions, and/or use of terms in the materials appended to this disclosure and those set forth herein, the descriptions, definitions and/or use of terms in this disclosure shall prevail.

Finally, it should be understood that the embodiments described in this disclosure are only used to illustrate the principles of the embodiments of this disclosure. Other deformations can also fall within the scope of this disclosure. As such, alternative configurations of embodiments of the present disclosure can be viewed as consistent with the teachings of the present disclosure as an example, not as a limitation. Correspondingly, the embodiments of the present disclosure are not limited to the embodiments expressly presented and described herein.

What is claimed is:

1. A high-hardness electronic glass, wherein raw materials of the high-hardness electronic glass comprises components, by a mass percentage, consisting of: 58.3%-62.93% of SiO₂, 23.02%-25.94% of Al₂O₃, 1.95%-5.02% of B₂O₃, 2.07%-4.21% of Li₂O, 0%-2.88% of Na₂O, 0%-2.29% of K₂O, 0%-3.30% of TiO₂, 0%-3.99% of ZrO₂, and 0%-4.17% of P₂O₅, wherein a sum of the mass percentages of the components is 100%.

2. The high-hardness electronic glass of claim 1, wherein a Vickers hardness value of the high-hardness electronic glass is within a range of 580-680 kgf/mm².

3. A preparation method for the high-hardness electronic glass of claim 1, comprising:
S1, obtaining a molded glass block by mixing the raw materials of the high-hardness electronic glass for melting, pouring and molding, and performing an annealing treatment;
S2, obtaining a base glass sheet by slicing the molded glass block, grinding, and polishing; and
S3, obtaining the high-hardness electronic glass containing a crystalline phase and a glassy phase by performing a heat treatment on the base glass sheet.

4. The preparation method of claim 3, wherein in the S1, a process of the melting includes: heating the raw materials to a first set temperature at a first heating rate and holding for a first set time; then heating to a second set temperature at a second heating rate and holding for a second set time; and then heating to a third set temperature at a third heating rate and holding for a third set time;
wherein the first heating rate is within a range of 10-15° C./min, the first set temperature is within a range of 1000-1100° C., the first set time is within a range of 30-45 min; the second heating rate is within a range of 5-7° C./min, the second set temperature is within a range of 1350-1400° C., the second set time is within a range of 1-2 h; and the third heating rate is within a range of 5-8° C./min, the third set temperature is within a range of 1645-1650° C., and the third set time is within a range of 4-5 h.

5. The preparation method of claim 3, wherein in the S1, a temperature of the annealing treatment is within a range of 600-650° C.

6. The preparation method of claim 3, wherein in the S2, a Vickers hardness value of the base glass sheet is within a range of 550-610 kgf/mm².

7. The preparation method of claim 3, wherein in the S2, an average transmittance of the base glass sheet in a visible light range is greater than 85%.

8. The preparation method of claim 3, wherein in the S3, the crystalline phase includes one or more of lithium silicate, lithium titanate, lithium aluminum silicate, or mullite.

9. The preparation method of claim 3, wherein in the S3, the heat treatment includes a nucleation treatment followed by a crystallization treatment; wherein a temperature of the nucleation treatment is within a range of 750-780° C., a time of the nucleation treatment is within a range of 0.5-1 h; and a temperature of the crystallization treatment is within a range of 850-880° C., and a time of the crystallization treatment is within a range of 0.5-1 h.
